(19) United States
(12) Patent Application Publication
(10) Pub. No.: US 2014/0029873 A1
(43) Pub. Date: Jan. 30, 2014

(54) Multilayer Film with Valve and Package Formed from the Film

(71) Applicants: José Pedro Cruz, Guadalajara (MX); Elmer Rix, Londrina (BR); Edson Bezerra Passos, Londrina (BR)

(72) Inventors: José Pedro Cruz, Guadalajara (MX); Elmer Rix, Londrina (BR); Edson Bezerra Passos, Londrina (BR)

(21) Appl. No.: 13/823,218

(22) PCT Filed: Sep. 20, 2011
(86) PCT No.: PCT/US11/52311

§ 371 Date: Oct. 15, 2013

(30) Foreign Application Priority Data
Sep. 23, 2010 (BR) PI1003492-7

(51) Int. Cl. B65D 77/22; B31B 1/25; B31B 1/84; B65D 33/01

(52) U.S. Cl. CPC B65D 77/225; B65D 33/01; B31B 1/25; B31B 1/84
USPC 383/45; 493/213; 493/223; 493/228

(57) ABSTRACT

A multilayer film comprising a valve is described. The multilayer film comprises an exterior layer and an interior layer. The interior layer comprises at least one aperture extending through the interior layer. A bonded portion and a non-bonded portion are between the interior layer and the exterior layer. The non-bonded portion comprises at least one channel and at least one passage. The at least one channel intersects the at least one passage at an angle greater than 0 degrees and less than 180 degrees, in one embodiment, the valve comprises the at least one aperture, the at least one channel and the at least one passage and provides for fluid communication from an outer surface of the interior layer to an atmosphere external to the multilayer film. The multilayer film may be provided as a web and may be used to form a variety of packages. Methods of manufacturing the film and methods of forming packages are also described.

### RELATED APPLICATIONS

The present patent application claims priority to Application No. PI1003492-7 filed with the Institute Nacional da Propriedade Industrial of Brazil on Sep. 23, 2010. The entirety of Application No. PI1003492-7 is incorporated in this application by this reference.

### BACKGROUND OF THE INVENTION

This present application relates to a multilayer film, specifically a multilayer film comprising a valve and the use of such film in a web and in a package. The film may be used to package products, including but not limited to powdered products, granulated products or similar products. The valve may be used to eliminate and discharge gases from inside such package.

The use of a multilayer film to form a package is known. A multilayer film comprises various layers. Each layer may have a specific function, such as a barrier layer, a printed layer or otherwise. In a web, the multilayer film may comprise a central area printed with a succession of repeating units for one wall of a package and longitudinal side areas printed with a succession of repeating units for the opposing wall of a package. The film may be formed into a package by various methods known to a person of ordinary skill in the art. Non-limiting examples of such methods include the use of a vertical form-fill-seal (VFFS) machine and the use of a horizontal form-fill-seal (HFFS) machine. On a VFFS machine, the film is folded or otherwise manipulated and longitudinally sealed to form a tube member. The tube member is then sealed across an end, transversally cut, filled with product, sealed across the opposite end and transversally cut. This series of steps is repeated until the web is transformed into individual packages. With each end seal and transversal cut, the transversal cut may separate the end seal into two seals, so that one end seal closes the mouth (or one end) of one package, the transversal cut separates the package from another subsequent package, and the other end seal closes the base (or other end) of the subsequent package. Each package may be substantially in pillow form. The package may be used for various product lines, including food and non-food powdered products, granulated products or similar products.

As a result of the packaging procedure, the film used to form the package and/or the products packaged, gas may be trapped or formed inside the package causing the package to bloat. Such bloated packages may result in problems in handling packages, storing packages, displaying packages, using packages or otherwise.

A non-limiting example of one product line is coffee powder. The multilayer film used for packages for such product line may comprise a barrier layer of, for example, metalized film, to preserve product quality, including but not limited to aroma. However, as a result of the packaging procedure, the barrier layer and/or the particular characteristics of coffee, gases form and cause the problems described above. To address these problems, numerous micro holes have been included in multilayer films used to form packages for coffee. However, such holes allow coffee particles to escape from the package, providing the consumer with the undesirable impression of a leaky package. Furthermore, such holes allow the external atmosphere to enter the package, compromising product quality.

What is needed is a multilayer film which may be used to form packages, where the multilayer film provides a route for gases to escape the package but prevents product from escaping and the external atmosphere from entering.

### BRIEF SUMMARY OF THE INVENTION

This need is met by a multilayer film comprising a valve. The multilayer film comprises an exterior layer and an interior layer. Each of the exterior layer and the interior layer may comprise various materials and various layers comprising various materials. The interior layer comprises at least one aperture extending through the interior layer. At various portions of the multilayer film, the exterior layer and the interior layer are bonded. At various other portions of the multilayer film, the exterior layer and the interior layer are not bonded. The non-bonded portion of the multilayer film comprises at least one channel and at least one passage.

The valve comprises the at least one aperture through the interior layer, the at least one channel between the exterior layer and the interior layer, and the at least one passage between the exterior layer and the interior layer; and the valve provides fluid communication from an outer surface of the interior layer to an atmosphere external to the multilayer film. In one embodiment, such fluid communication is provided as follows: The aperture is in fluid communication with a first area of the channel; the second area of the channel intersects the passage at an angle greater than 0 degrees and less than 180 degrees and is in fluid communication with the passage; and the passage extends laterally from a first edge of the multilayer film to an opposing second edge and a first end of the passage and a second end of the passage is each in fluid communication with an atmosphere external to the multilayer film.

In one embodiment, the multilayer film described above may be used to form a web.

In another embodiment, the multilayer film described above may be used to form a package. The package comprises a first seal connecting a first side of the multilayer film to an opposing second side of the multilayer film (or a first edge of the multilayer film to an opposing second edge of the multilayer film) to define a tube member. The package further comprises a second seal through a first wall and a second wall of the tube member such that the second seal extends laterally across the width of both the first wall and the second wall and is near one end of the tube member. A product may then be placed in the tube member sealed with the second seal. A third seal may then be provided through the first wall and the second wall of the tube member such that the third seal extends laterally across the width of both the first wall and the second wall and is near the other end of the tube member. In this embodiment, a valve for the package comprises the at least one aperture through the interior layer, the at least one channel between the exterior layer and the interior layer, and the at least one passage between the exterior layer and the interior layer.

In one embodiment of the package formed from the multilayer film, the first seal comprises a first outlet having a first area and a second area. In this embodiment, a valve for the package comprises the at least one aperture through the interior layer, the at least one channel between the exterior layer and the interior layer, the at least one passage between the exterior layer and the interior layer, and the first outlet, where a first area of the first outlet is in fluid communication with a first end of the passage and a second area of the first outlet is in fluid communication with a second end of the passage.

In another embodiment of the package formed from the multilayer film, the second seal comprises a second outlet and a third seal comprises a third outlet. In this embodiment, a valve for the package comprises the at least one aperture through the interior layer, the at least one channel between the exterior layer and the interior layer, the at least one passage between the exterior layer and the interior layer, the second outlet and the third outlet, where the second outlet is in fluid communication with a second end of the passage and the third outlet is in fluid communication with a first end of the passage.

In a further embodiment of the present application, a method of making the multilayer film described above is described. This method comprises the steps of providing a first layer as the exterior layer, providing a second layer as the interior layer, providing the bonded portion between the interior layer and the exterior layer, providing the non-bonded portion between the interior layer and the exterior layer to form the at least one channel and the at least one passage, and providing the at least one aperture in the interior layer.

In another embodiment of the present application, a method of forming a package comprising the multilayer film described above is described. This method comprises the steps of providing a web of the multilayer film, providing a first seal connecting a first side of the multilayer film to an opposing second side of the multilayer film (or a first edge of the multilayer film to an opposing second edge of the multilayer film) to define a tube member, providing a second seal through a first wall and a second wall of the tube member such that the second seal extends laterally across the width of both the first wall and the second wall and is near one end of the tube member, providing a product in the tube member sealed with the second seal, and providing a third seal through the first wall and the second wall of the tube member such that the third seal extends laterally across the width of both the first wall and the second wall and is near the other end of the tube member. In this embodiment, a valve for the package comprises the at least one aperture through the interior layer, the at least one channel between the exterior layer and the interior layer, and the at least one passage between the exterior layer and the interior layer.

In one embodiment of the method of forming a package from the multilayer film, the method further comprises the step of forming a first area of a first outlet in the first seal and the step of forming a second area of a first outlet in the first seal. In this embodiment, a valve for the package comprises the at least one aperture through the interior layer, the at least one channel between the exterior layer and the interior layer, the at least one passage between the exterior layer and the interior layer, and the first outlet, as the first area of the first outlet is in fluid communication with a first end of the passage and the second area of the first outlet is in fluid communication with a second end of the passage.

In another embodiment of the method of forming a package from the multilayer film, the method further comprises the step of forming a second outlet in the second seal and the step of forming a third outlet in the third seal. In this embodiment, a valve for the package comprises the at least one aperture through the interior layer, the at least one channel between the exterior layer and the interior layer, the at least one passage between the exterior layer and the interior layer, the second outlet and the third outlet, as the second outlet is in fluid communication with a second end of the passage and the third outlet is in fluid communication with a first end of the passage.

The embodiments described in the present application provide a route for gases to escape or to be discharged from a package but also prevent product from escaping and the external atmosphere from entering. When the pressure in the package is higher than the pressure in the external atmosphere, the gas enters the valve through the at least one aperture, flows through the at least one channel and flows through the at least one passage to the external atmosphere. In some embodiments, the gas flows through a first outlet or a second and a third outlet on its way to the passage ends and the external atmosphere. However, at the same time, product that may possibly enter the at least one aperture does not flow through the at least one channel or the at least one passage due to the configuration and position of such elements. Therefore, product does not escape the package to the external atmosphere. Furthermore, gas does not flow from the external atmosphere to the product, as the pressure in the package and the pressure in the external atmosphere tend to equalize after gas in the package is discharged to the external atmosphere (as described above). Additionally, the weight of the package and the configuration and position of the at least one passage, the at least one channel and the at least one aperture make such ingress difficult. As such, the valve may operate as a non-return/one-way/check/gas-discharge valve to allow gas egress to the external atmosphere but to prevent gas ingress from the external atmosphere.

### BRIEF DESCRIPTION OF THE DRAWINGS

FIG. 1 is a plan view of a first embodiment of a multilayer film according to the present application.

FIG. 2 is a cross-sectional view of the multilayer film of FIG. 1 , taken along the lines 2-2 of FIG. 1.

FIG. 3 is a cross-sectional view of the multilayer film of FIG. 1 , taken along the lines 3-3 of FIG. 1.

FIG. 4 is a plan view of a second embodiment of a multilayer film according to the present application.

FIG. 5 is a plan view of a third embodiment of a multilayer film according to the present application.

FIG. 6 is a plan view of a fourth embodiment of a multilayer film according to the present application.

FIG. 7 is a plan view of a fifth embodiment of a multilayer film according to the present application.

FIG. 8 is a plan view of a sixth embodiment of a multilayer film according to the present application.

FIG. 9 is a plan view of a web with three sections comprising the multilayer film of FIG. 1.

FIG. 10 is a perspective view of a first embodiment of a package comprising the multilayer film of FIG. 1.

FIG. 11 is a plan view of a second embodiment of a package comprising the multilayer film of FIG. 1.

FIG. 12 is a perspective view of a third embodiment of a package comprising the multilayer film of FIG. 1.

FIG. 13 is a cross-sectional view of the package of FIG. 12, taken along the lines 13-13 of FIG. 12

FIG. 14 is a perspective view of method of manufacturing packages according to the present application.

### DETAILED DESCRIPTION OF THE INVENTION

As used throughout this application, the term “film” refers to a plastic web of any thickness and is not limited to a plastic web having a thickness of less than about 10 mil. The term “sheet” refers to a plastic web of any thickness and is not limited to a plastic web having a thickness of greater than about 10 mil.

As used throughout this application, the term “web” refers to a continuous film or a continuous sheet.

As used throughout this application, the term “package” refers to any device used to wholly or partially surround an item. A package may take many, various forms. For example, the term “package” may include bags that wholly surround an item (or items) to be packaged; the term “package” may also include films that partially surround an item (or items) to be packaged and, when used in conjunction with another material (such as a tray), wholly surround an item (or items).

As used throughout this application, the term “about” refers to approximately, rounded up or down to, reasonably close to, in the vicinity of, or the like. The term “approximate” is synonymous with the term “about.”

As used throughout this application, the term “adjacent” refers to being near or close in proximity. It includes but is not limited to being reasonably close to or in the vicinity of as well as touching, having a common boundary or having direct contact.

As used throughout this application, the term “exterior layer” refers to a layer comprising the outermost surface of a film, sheet, web, package or other article. The term “interior layer” refers to a layer comprising the innermost surface of a film, sheet, web, package or other article. Additionally, the exterior layer and the interior layer each have an inner surface and an outer surface. The term “inner surface” refers to a surface touching another layer, and the term “outer surface” refers to a surface not touching another layer.

As used throughout this application, the term “intermediate layer” refers to a layer that is positioned between two other layers. An intermediate layer has two inner surfaces.

As used throughout this application, the term “multilayer” refers to a plurality of layers in a single structure generally in the form of a film, sheet or web which may be made from a polymeric material or a non-polymeric material bonded together by any conventional means known in the art (i.e., coextrusion, lamination, coating or a combination of such). The multilayer film described in the present application comprises a film including as many layers as desired and, preferably, at least two layers.

As used throughout this application, the term “exterior multilayer film” refers to a multilayer film comprising the outermost surface of a film, sheet, web, package or other article. The term “interior multilayer film” refers to a multilayer film comprising the innermost surface of a film, sheet, web, package or other article.

As used throughout this application, the term “coextruded” refers to the process of extruding two or more polymer materials through a single die with two or more orifices arranged so that the extrudates merge and weld together into a laminar structure before chilling (i.e., quenching).

Coextrusion methods known to a person of ordinary skill in the art include but are not limited to blown film coextrusion, slot cast coextrusion and extrusion coating. The flat die or slot cast process includes extruding polymer streams through a flat or slot die onto a chilled roll and subsequently winding the film onto a core to form a roll of film for further processing.

As used throughout this application, the term “blown film” refers to a film produced by the blown coextrusion process. In the blown coextrusion process, streams of melt-plastrfied polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel, and then rapidly cooled or quenched by any of various methods known to those of skill in the art.

As used throughout this application, the term “in fluid communication” refers to free movement of fluid (e.g. air or other gas) from one place to another through an open pathway for fluid. When specified parts are “in fluid communication,” fluid flowing past one specified part also flows past the other specified part with the specified parts being connected by fluid flow and/or the specified parts communicating through fluid flow

As used throughout this application, terms such as “preferably” and “typically” are not used to limit the scope or to imply that certain features are critical, essential or even important to the structure of function. Rather, these (and similar) terms are merely intended to highlight alternative or additional features that may or may not be used in a particular embodiment.

As used throughout this application, the term “layer” refers to a discrete film or sheet component which is coextensive with the film or sheet and has a substantially uniform composition. In referring to a monolayer film, “film,” “sheet” and “layer” are synonymous.

As used throughout this application, the term “aperture” refers to hole, vent, score, slit, slot, perforation, puncture, orifice, opening, inlet or otherwise. Such aperture may be formed by mechanical means, by optical ablation or by other method known to a person of ordinary skill in the art.

As used throughout this application, the term “optical ablation” refers to a method of localized vaporization or decomposition of polymeric material by means of a controlled laser beam which may be used to form an aperture in a thermoplastic material.

As used throughout this application, the term “polymer” refers to a material which is the product of a polymerization or copolymerization reaction of natural, synthetic or combined natural and synthetic monomers and/or co-monomers and is inclusive of homopolymers, copolymers, terpolymers, etc. In general, the layers of the multilayer film described in the present application may comprise a single polymer, a mixture of a single polymer and non-polymeric material, a combination of two or more polymers blended together, or a mixture of a blend of two or more polymers and non-polymeric material. It will be noted that many polymers may be synthesized by the mutual reaction of complementary monomers. It will also be noted that some polymers are obtained by the chemical modification of other polymers such that the structure of the macromolecules that constitute the resulting polymer may be thought of as having been formed by the homopolymerization of a hypothetical monomer.

As used throughout this application, the term “thermoplastic” refers to a polymer or polymer mixture that softens when exposed to heat and then returns to its original condition when cooled to room temperature. In general, thermoplastic materials may include natural or synthetic polymers. Thermoplastic materials may further include any polymer that is cross-linked by either radiation or chemical reaction during manufacturing or post-manufacturing processes.

As used throughout this application, the term “bonded portion” refers to a portion of a multilayer film, sheet, web, package or other article in which layers are bonded, adhered, joined, attached, affixed, connected or otherwise such that no consequential space, gap, open area or otherwise is formed between the layers. Such bonded portion may be formed via heat and pressure, adhesive or other method known to a person of ordinary skill in the art.

As used throughout this application, the term “non-bonded portion” refers to a portion of a multilayer film, sheet, web, package or other article in which layers are not bonded, adhered, joined attached, affixed, connected, laminated or otherwise such that a consequential space, gap, open area or otherwise is formed between the layers. Such non-bonded portion may be formed via an area void of adhesive, an adhesive skip, a pattern-applied adhesive or other method known to a person of ordinary skill in the art.

As used throughout this application, the term “laterally” refers to traversing from side to side, along the length of, from one point to another or otherwise. It is not limited to the machine direction and/or the transverse direction.

As used throughout this application, the term “sealant layer” refers to a layer or layers of a film, sheet, web, package or otherwise involved in the sealing of the film, sheet, web, package or otherwise to itself, to another layer of the same or another film, web, sheet, package or otherwise, and/or to another article, such as a tray. In general, the sealant layer is an interior layer of any suitable thickness that provides for the sealing of the film, sheet, web, package or otherwise to itself or to another layer. With respect to packages having only fin-type seals, as opposed to lap-type seals, the phrase “sealant layer” generally refers to the interior layer of a film, sheet, web, package or otherwise. The sealant layer may also serve as a food contact layer in the packaging of foods.

As used throughout this application, the term “sealant material” refers to any material suitable for a sealant layer. Sealant material includes but is not limited to heat sealable polymeric material such as a polyolefin (e.g., polyethylene or polypropylene) or blend of such. Such polyolefins include, for example, polyethylenes such as low density polyethylene (LDPE), high density polyethylene (HDPE), ethylene alpha-olefin copolymers (EAO) (also referred to as “copolymers of ethylene and at least one alpha-olefin”) (including, for example, plastomers), very low density polyethylene (VLDPE), linear low density polyethylene (LLDPE), polypropylene homopotymers, polypropylene copolymers, polybutylene homopolymers, polybutylene copolymers or homogeneous polyolefin resins, such as those made with constrained geometry catalysts or metallocene single-site catalysts, including, for example, copolymers of ethylene or propylene with at least one C_{4-8 or higher} alpha-olefins (e.g., 1-butene, 1-hexene or 1-octene or combinations of such) with a majority of polymeric units derived from ethylene or propylene. Ethylene vinyl acetate (EVA) copolymers, ethylene butyl acrylate copolymers (EBA), ethylene methyl acrylate copolymers (EMA), ethylene methacrylic acid copolymers (EMAA), ethylene ethyl acrylate copolymers (EEA), ethylene acrylic acid copolymers (EAA), polyesters and ionomers are also examples of sealant materials. Suitable sealant materials also include those disclosed in U.S. Pat. Nos. 6,964,816; 6,861 ,127; 6,815,023; 6,773,820; 6,682,825; 6,316,067; 5,759,648; and 5,663,002 and U.S. Patent Application Publications 2005/0129969 and 2004/0166262, each of which is incorporated in its entirety in this application by this reference. Sealant materials may also comprise polyamides such as nylon, polyesters such as polyethylene terephthalate (PET), polystyrene, polycarbonates, cyclic olefin copolymers, polyacrylonitrile or copolymers or blends of such. Specific examples of sealant materials include but are not limited to ethylene alpha-olefin copolymers commercially available from The Dow Chemical Company (Midland, Mich.) under trade names Affinity™, Attane™ or Elite™ (including 1-octene as an alpha-olefin) and from ExxonMobil Chemical Company (Houston, Tex.) under a trade name Exact™ (including 1-hexene, 1-butene and 1-octene as comonomers) and ionomers commercially available from E. I. du Pont de Nemours and Company (Wilmington, Del.) under a trade name Surlyn®.

As used throughout this application, the term “polyethylene” or “PE” refers (unless indicated otherwise) to ethylene homopolymers and copolymers. Such copolymers of ethylene include copolymers of ethylene with at least one alpha-olefin and copolymers of ethylene with other units or groups such as vinyl acetate or otherwise. The term “polyethylene” or “PE” will be used without regard to the presence or absence of substituent branch groups.

As used throughout this application, the term “high density polyethylene” or “HDPE” refers to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.940 g/cm³ to about 0.958 g/cm³. HDPE includes polymers made with Ziegler or Phillips type catalysts and polymers made with single-site metallocene catalysts. HDPE also includes high molecular weight polyethylenes. In contrast to HDPE, whose polymer chain has some branching, are “ultra high molecular weight polyethylenes,” which are essentially unbranched specialty polymers having a much higher molecular weight than the high molecular weight HDPE.

As used throughout this application, the term “low density polyethylene” or “LDPE” refers to branched homopolymers having densities between 0.915 g/cm³ and 0.930 g/cm³, as well as copolymers containing polar groups resulting from copolymerization (such as with vinyl acetate or ethyl acrylate). LDPE typically contains long branches off the main chain (often termed “backbone”) with alkyl substituents of two to eight carbon atoms.

As used throughout this application, the term “copolymer” refers to a polymer product obtained by the polymerization reaction or copolymerization of at least two monomer species. Copolymers may also be referred to as bipolymers. The term “copolymer” is also inclusive of the polymerization reaction of three, four or more monomer species having reaction products referred to terpolymers, quaterpolymers, etc.

As used throughout this application, the term “copolymer of ethylene and at least one alpha-olefin” (also referred to as “ethylene-alpha olefin copolymer”) refers to a modified or unmodified copolymer produced by the co-polymerization of ethylene and any one or more alpha-olefins. Suitable alpha-olefins include, for example, C₃ to C₂₀ alpha-olefins such as propene, 1-butene, 1-pentene, 1-hexene, 1-octene, 1-decene and combinations of such. The co-polymerization of ethylene and an alpha-olefin may be produced by heterogeneous catalysis, such as co-polymerization reactions with Ziegler-Natta catalysis systems, including, for example, metal halides activated by an organometallic catalyst (e.g., titanium chloride) and optionally containing magnesium chloride complexed to trialkyl aluminum. Heterogeneous catalyzed copolymers of ethylene and an alpha-olefin may include linear low density polyethylene (LLDPE), very low density polyethylene (VLDPE) and ultra low density polyethylene (ULDPE) (commercially available as, for example, Dowlex™ from The Dow Chemical Company (Midland, Mich.)). Additionally, the co-polymerization of ethylene and an alpha-olefin may also be produced by homogeneous catalysis, such as co-polymerization reactions with metallocene catalysis systems which include constrained geometry catalysts, (e.g., monocyclopentadienyl transition-metal complexes). Homogeneous catalyzed copolymers of ethylene and alpha-olefin may include modified or unmodified ethylene alpha-olefin copolymers having a long-chain branched (i.e., 8-20 pendant carbons atoms) alpha-olefin co-monomer (commercially available as, for example, Affinity™ and Attane™ from The Dow Chemical Company (Midland, Mich.)), linear copolymers (commercially available as, for example, Tafmer™ from the Mitsui Petrochemical Corporation (Tokyo, Japan)), and modified or unmodified ethylene alpha-olefin copolymers having a short-chain branched (i.e., 3-6 pendant carbons atoms) alpha-olefin co-monomer (commercially available as, for example, Exact™ from ExxonMobil Chemical Company (Houston, Tex.)). In general, homogeneous catalyzed ethylene alpha-olefin copolymers may be characterized by one or more methods known to those of skill in the art, including but not limited to molecular weight distribution (Mw/Mn), composition distribution breadth index (CDBI), narrow melting point range and single melting point behavior.

As used throughout this application, the term “modified” refers to a chemical derivative, such as one having any form of anhydride functionality (e.g., anhydride of maleic acid, crotonic acid, citraconic acid, itaconic acid, fumaric acid, etc.), whether grafted onto a polymer, copolymerized with a polymer or blended with one or more polymers. The term is also inclusive of derivatives of such functionalities, such as acids, esters and metal salts derived from such.

As used throughout this application, the term “polypropylene” or “PP” refers to a homopolymer or copolymer having at least one propylene monomer linkage within the repeating backbone of the polymer. The propylene linkage can be represented by the general formula: [CH₂—CH(CH₃)]ₙ.

As used throughout this application, the term “ionomer” refers to a partially neutralized acid copolymer, such as a metal salt neutralized copolymer of ethylene and acrylic or methacrylic acid.

As used throughout this application, the term “polyester” refers to a homopolymer or copolymer having an ester linkage between monomer units which may be formed, for example, by condensation polymerization reactions between a dicarboxylic acid and a diol. The ester linkage can be represented by the general formula: [O—R—OC(O)—R′—C(O)]ₙ where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., lactic acid, oxalic acid, maleic acid, succinic acid, glutaric acid, adipic acid, pimelic acid, suberic acid, azelaic acid, sebacic acid, and the like) or may be aromatic or alkyl-substituted aromatic (e.g., various isomers of phthalic acid, such as paraphthalic acid (or terephthalic acid), isophthatic acid and naphthalic acid). Specific examples of a useful diol include but are not limited to ethylene glycol, propylene glycol, trimethylene glycol, 1,4-butane diol, neopentyl glycol, cyclohexane diol and the like. Polyesters may include a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate; a copolymer of terephthalate and isophthalate including but not limited to polyethylene terephthalate/isophthalate copolymer; a homopolymer or copolymer of aliphatic esters including but not limited to polylactic acid (PLA); polyhydroxyalkonates including but not limited to poly hydroxy propionate, poly(3-hydroxybutyrate) (PH3B), poly(3-hydroxyvalerate) (PH3V). poly(4-hydroxybutyrate) (PH4B), poly(4-hydroxyvalerate) (PH4V), poly(5-hydroxyvalerate) (PH5V), poly(6-hydroxydodecanoate) (PH6D); and blends of any of these materials.

As used throughout this application, the term “polystyrene” or “PS” refers to a homopolymer or copolymer having at least one styrene monomer linkage (such as benzene monomer (i.e., C₆H₅) with an ethylene substituent) within the repeating backbone of the polymer. The styrene linkage can be represented by the general formula: [CH₂—CH₂(C₆H₅)]ₙ. Polystyrene may be formed by any method known to a person or ordinary skill in the art.

As used throughout this application, the term “barrier” refers to any material which controls a permeable element of the film, sheet, web, package or otherwise against aggressive agents and includes but is not limited to oxygen barrier, moisture (e.g., water, humidity, etc.) barrier, chemical barrier, heat barrier, light barrier and odor barrier. The term “barrier layer” refers to a layer of the film, sheet, web, package or otherwise which controls such permeable element.

As used throughout this application, the term “ethylene vinyl alcohol copolymer” or “EVOH” refers to copolymers comprised of repeating units of ethylene and vinyl alcohol. Ethylene vinyl alcohol copolymers can be represented by the general formula: [(CH₂—CH₂)ₘ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. The degree of hydrolysis is preferably at least 50% and, more preferably, at least 85%. Preferably, ethylene vinyl alcohol copolymers comprise from about 28 mole percent to about 48 mole percent ethylene, more preferably, from about 32 mole percent to about 44 mole percent ethylene, and, even more preferably, from about 38 mole percent to about 44 mole percent ethylene. Specific non-limiting examples of EVOH include EVAL™ H171 available from EVAL Company of America (Houston, Tex.); Evasin® EV-3801 V available from Chang Chun Petrochemical Co., Ltd. (Taipei, Taiwan); and Soarnol® ET3803 available from Soarus L.L.C. (Arlington Heights, Ill.). As used throughout this application, the term “polyamide” or “PA” or “nylon” refers to a homopolymer or copolymer having an amide linkage between monomer units which may be formed by any method known to those skilled in the art. The amide linkage can be represented by the general formula: [C(O)—R—C(O)—NH—R′—NH]ₙ where R and R′ are the same or different alkyl (or aryl) group. Examples of nylon polymers include but are not limited to nylon 6 (polyeaprotactam), nylon 11 (polyundecanolactam), nylon 12 (polyauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), and nylon 12,12 (polydodecamethylene dodecanediamide). Examples of nylon copolymers include but are not limited to nylon 6,6/6 copolymer (polyhexamethylene adipamide/caprolactam copolymer), nylon 6,6/9 copolymer (polyhexamethylene adipamide/azelaiamide copolymer), nylon 6/6,6 copolymer (polycaprolactam/hexamethylene adipamide copolymer), nylon 6,2/6,2 copolymer (polyhexamet ylene ethylenediamide/hexamethylene ethylenediamide copolymer), and nylon 6,6/6,9/6 copolymer (polyhexamethylene adipamide/hexamethylene azelaiamide/caprolactam copolymer). Examples of aromatic nylon polymers include but are not limited to nylon 4,1, nylon 6,1, nylon 6,6/6I copolymer, nylon 6.6/6T copolymer, nylon MXD6 (poly-m-xylylene adipamide), poly-p-xylylene adipamide, nylon 6I/6T copolymer, nylon 6T/6I copolymer, nylon MXDI, nylon 6/MXDT/I copolymer, nylon 6T (polyhexamethylene terephthalamide), nylon 12T (polydodecamethylene terephthalamide), nylon 66T, and nylon 6-3-T (poly(trimethyl hexamethylene terephthalamide).

As used throughout this application, “polyvinylidene chloride” or “PVDC” refers to copolymers of vinylidene chloride. PVDC may be formed from polymerization of vinylide chloride with various monomers including but not limited to acrylic esters and unsaturated carboxyl groups. Vinylidene chloride copolymers include but are not limited to vinylidene chloride-vinyl chloride copolymers, vinylidene chloride-methyl acrylate copolymers and vinylidene chlortde-acrylonitrile copolymers. Vinylidene chloride copolymer is also known as saran.

As used throughout this application, “metalized film” and “metal-oxide coated film” refer to any thermoplastic material upon which is deposited a layer of metal or metal oxide. Examples of thermoplastic materials include polyolefin resins such as polyethylene, polypropylene, polyisoprene, polybutene, poly-3-methyl-1-butene, poly-4-methyl-1-pentene, polybutadiene, polystyrene and copolymers of constituent monomers of the foregoing polymers (e.g. ethylene propylene copolymer; linear low density polyethylenes containing 1-butene, 4-methyl-1-pentene, 1-hexene, 1-octene or the like as a comonomer; block copolymer of propylene and ethylene; styrene butadiene copolymer and mixtures, graft products, cross-linked products, block copolymers, etc.), ethylene vinyl acetate copolymer and its saponification products, halogen-containing polymers (e.g. polyvinylidene chloride, polyvinyl chloride, polyvinyl fluoride, polyvinylidene fluoride, polychloroprene, chlorinated rubber, etc.), polymers of unsaturated carboxylic acids and their derivatives (e.g. polyalkyl methacrylate, polyalkyl acrylate, polyacrylonitrile, copolymers of constituent monomers of the foregoing polymers with other monomers, such as acrylonitrile styrene copolymer, ABS resins, ethylene alkyl acrylate copolymer, ethylene glycidyl methacrylate copolymer, ethylene methacrylic acid copolymer and its ionic cross-linked products, etc.), polyacetal, polycarbonate, polyester (e.g. polyethylene terephthalate, polybutylene terephthalate, polybutylene terephthalate, polyethylene naphthalate, etc.), polyamide, polyphenylene oxide, polysulfone, etc. Among these thermoplastic materials, polyester, polypropylene and polyamide may be preferred for the metalized film in the multilayer film described in the present application. The metal or metal oxide deposited as a layer on the thermoplastic material may be composed of any suitable metal. Layers may be simple metals, such as aluminum, titanium, chromium, nickel, zinc, copper, bronze, gold, silver, or alloys of such, or may be metal oxides such as aluminum oxide, silicon oxide, ferrite, indium oxide, etc. The metals and metal oxides may be deposited as a layer on a surface of the thermoplastic material according to procedures known to a person of ordinary skill in the art. Such procedures include but are not limited to electroplating, sputtering and vacuum vapor-deposition. The thickness of the metal or metal oxide deposited may be about 20 to about 1000 Angstroms.

As used throughout this application, the term “oriented” refers to a film, sheet, web or otherwise which has been elongated in at least one of the machine direction or the transverse direction. Such elongation is accomplished by procedures known to a person of ordinary skill in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving the tubular extrusion die is cooled, collapsed and then oriented by reheating, reinflating to form a secondary bubble and recooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film, sheet, web, package or otherwise. Upon subsequent heating of an unrestrained, unannealed, oriented article to its orientation temperature, heat-shrinkage (as measured in accordance with ASTM Test Method D2732, “Standard Test Method for Unrestrained Linear Thermal Shrinkage of Plastic Film and Sheeting,” which is incorporated in its entirety in this application by this reference) may be produced. Heat-shrinkage may be reduced if the oriented article is first annealed or heat-set by heating to an elevated temperature, preferably to an elevated temperature which is above the glass transition temperature and below the crystalline melting point of the polymer comprising the article. This reheating/annealing/heat-setting step also provides a polymeric web of uniform flat width. The polymeric web may be annealed (i.e., heated to an elevated temperature) either in-line with (and subsequent to) or off-line from (in a separate process) the orientation process.

As used throughout this application, the term “tie material” refers to a polymeric material serving a primary purpose or function of adhering two surfaces to one another, presumably the planar surfaces of two film layers. For example, a tie material adheres one film layer surface to another film layer surface or one area of a film layer surface to another area of the same film layer surface. The tie material may comprise any polymer, copolymer or blend of polymers having a polar group or any other polymer, homopolymer, copolymer or blend of polymers, including modified and unmodified polymers (such as grafted copolymers) which provide sufficient interlayer adhesion to adjacent layers comprising otherwise nonadhering polymers. As a non-limiting example, pattern-applied adhesive may be preferred for the tie material between the exterior layer and the interior layer in the multilayer film described in the present application.

As used throughout this application, the term “duct” refers to a channel, conduit, canal, passage, passageway or the like.

As used throughout this application, the term “registered” refers to the placement of a component. In the multilayer film and package described in the present application, various channels and/or passages may be registered. As such, in forming a package, various channels and/or passages may be located in the body of the package, not fully or solely contained by a seal or seals of the package.

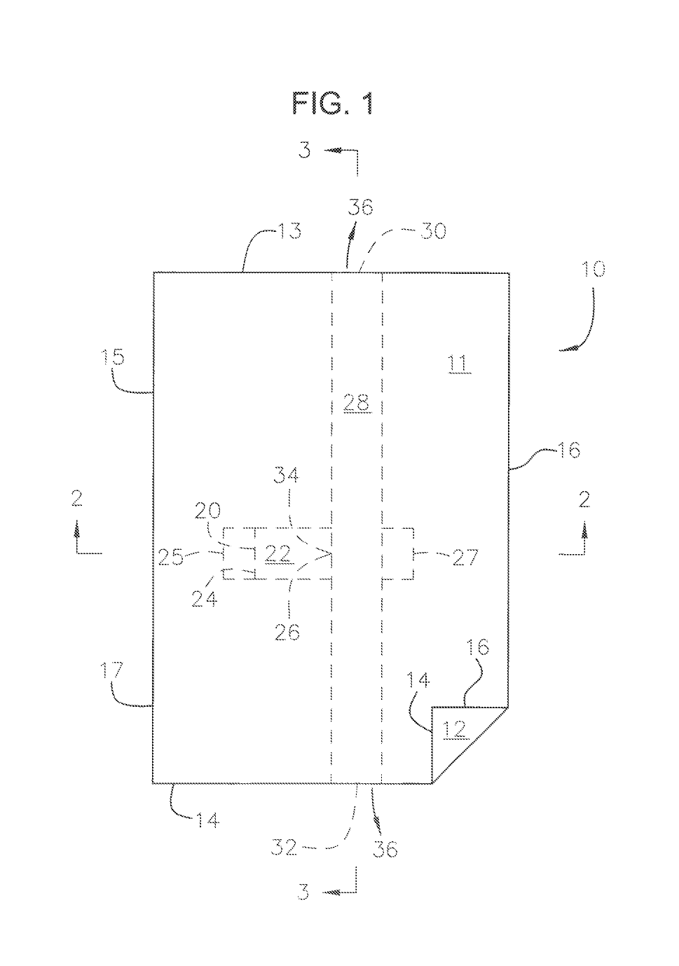

Referring now to the drawings, with elements depicted as illustrative and not necessarily to scale and with the same (or similar) reference numbers denoting the same (or similar) features throughout the drawings, FIG. 1 is a plan view of a first embodiment of a multilayer film according to the present application. Multilayer film 10 has top surface 11 and bottom surface 12. FIG. 1 depicts a corner of multilayer film 10 turned upward to reveal bottom surface 12. Multilayer film 12 also has first edge 13 and opposing second edge 14. First edge 13 and opposing second edge 14 are connected by first side 15 and opposing second side 16. First edge 13 and opposing second edge 14 are generally parallel to each other when multilayer film 10 is in a lay flat, planar state. First side 15 and opposing second side 16 are also generally parallel to each other when multilayer film 10 is in a lay flat, planar state. First edge 13 and opposing second edge 14 is each generally perpendicular to each of first side 15 and opposing second side 16 when multilayer film 10 is in a lay flat, planar state. First edge 13, opposing second side edge 14, first side 15 and opposing second side 16 form perimeter 17, circumscribing each of top surface 1 and bottom surface 12.

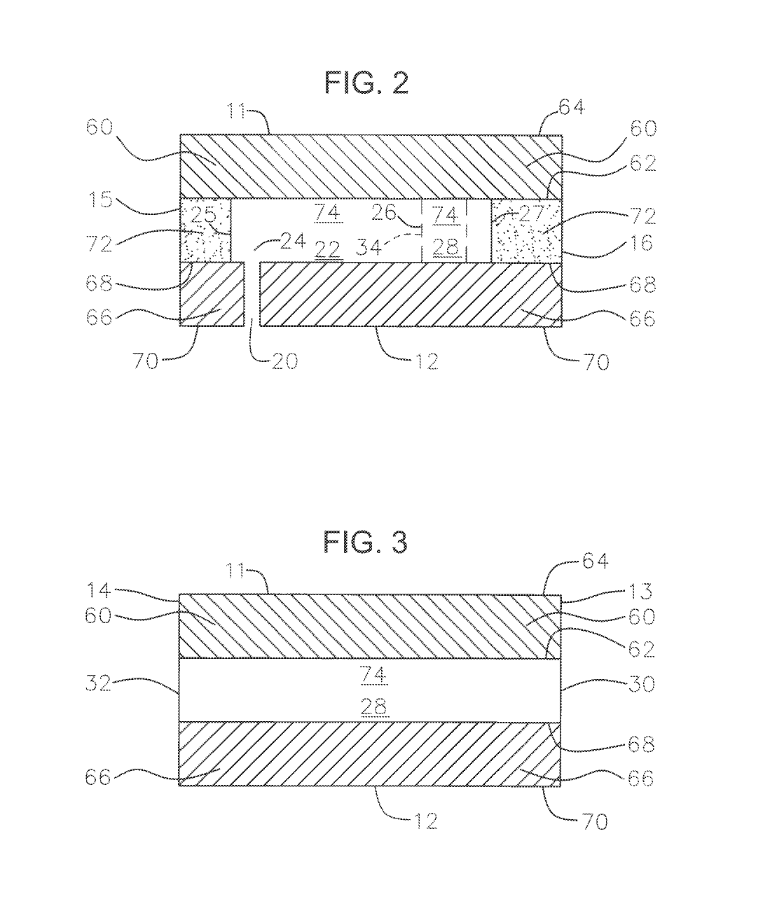

FIG. 2 is a cross-sectional view of the multilayer film of FIG. 1, taken along the lines 2-2 of FIG. 1. Interior layer 66 is adjacent to exterior layer 60. First channel 22 is formed by non-bonded portion 74 between exterior layer 60 and interior layer 66. First aperture 20 is formed in interior layer 66 of multilayer film 10 and has a depth extending from interior layer outer surface 70 to interior layer inner surface 68. First aperture 20 is located such that it is in fluid communication with first channel first area 24. For example, first aperture 20 may be located at or near first channel first end 25, as depicted in FIG. 1 and FIG. 2; however, provided there is fluid communication with first channel first area 24, first aperture 20 is not limited to this location. At first channel second area 26, first channel 22 intersects with passage 28 at first channel-passage intersection point 34. First channel second area 26 may be located at or near first channel second end 27 or may be located at a location separate from first channel second end 27, as depicted in FIG. 1 and FIG. 2. No matter its position relative to first channel second end 27, first channel second area 26 Is located at or near first channel-passage intersection point 34 such that first channel second area 26 is in fluid communication with passage 28.

In FIG. 1, the intersection of first channel second area 26 with passage 28 is depicted as occurring at an approximately 90-degree angle. However, such intersection may occur at any angle, provided such angle is greater than 0 degrees and less than 180 degrees. For example, such intersection could occur at any angle from about 15 degrees to about 165 degrees, from about 30 degrees to about 150 degrees, from about 45 degrees to about 135 degrees, from about 60 degrees to about 120 degrees or from about 75 degrees to about 105 degrees. As further non-limiting examples, such intersection could occur at a 15-degree angle, a 30-degree angle, a 45-degree angle, a 60-degree angle, a 75-degree angle, a 90-degree angle, a 105-degree angle, a 120-degree angle, a 135-degree angle, a 150-degree angle, a 165-degree angle or at any angle between 0 and 180 (not including 0 degrees or 180 degrees).

FIG. 3 is a cross-sectional view of the multilayer film of FIG. 1, taken along the lines 3-3 of FIG. 1. Passage 28 is formed by non-bonded portion 74 between interior layer 66 and exterior layer 60. Passage 28 has passage first end 30 and passage second end 32 and extends from first edge 13 to opposing second edge 14. As depicted in FIG. 1, passage first end 30 and passage second end 32 may be in fluid communication with external atmosphere 36. In the embodiment of FIG. 1, FIG. 2 and FIG. 3, first aperture 20, first channel 22 and passage 28 form the valve allowing for fluid communication from an interior layer outer surface to an external atmosphere.

As shown in FIG. 2 and FIG. 3, exterior layer 60 has exterior layer inner surface 62 and exterior layer outer surface 64, and interior layer 66 has interior layer inner surface 68 and interior layer outer surface 70. Top surface 11 comprises exterior layer outer surface 64, and bottom surface 12 comprises interior layer outer surface 70. Bonded portion 72 and non-bonded portion 74 are between exterior layer 60 and interior layer 66.

Interior layer 66 may be a sealant layer and may comprise sealant material, as described and defined above. Interior layer 66 may be a multilayer film. A non-limiting example of such interior multilayer film comprises a first layer of polyethylene, a second layer of polyethylene and a third layer of polypropylene. Another non-limiting example of an interior multilayer film comprises a first layer of sealant material (as described and defined above) and a second layer of polyester. A further non-limiting example of an interior multilayer film comprises a coextruded polypropylene/polyethylene, with a first layer of polypropylene and a second layer of polyethylene.

Exterior layer 60 may be a barrier layer and may comprise barrier material. Examples of barrier material include but are not limited to ethylene vinyl alcohol copolymer, polyvinyl alcohol, polyester, polypropylene, polyamide, metalized film, metal-oxide coated film, foil, nanocomposite, polyvinytidene chloride, polyglycolic acid, polyacrylonitrile, polyalkylene carbonate, methyl acrylate copolymer, polyethylene or blends of the above. Exterior layer 60 may be a multilayer film. A non-limiting example of such exterior multilayer film comprises a first layer of polyester and a second layer of foil, metalized film or metal-oxide coated film. Another non-limiting example of an exterior multilayer film comprises a first layer of polyester, polypropylene or polyamide and a second layer of ethylene vinyl alcohol copolymer. A further non-limiting example of an exterior multilayer film comprises a first layer of polyethylene, a second layer of polyethylene, a third layer of ethylene vinyl alcohol copolymer, a fourth layer of polyethylene and a fifth layer of polyethylene. An additional non-limiting example of an exterior multilayer film comprises a first layer of polyethylene or polypropylene, a second layer of polyamide, a third layer of ethylene vinyl alcohol copolymer, a fourth layer of polyamide and a fifth layer of polyethylene or polypropylene.

Considering the examples of interior multilayer films and exterior multilayer films described above, non-limiting examples of various structures for multilayer film 10 include the following (with “/” used to denote the layer boundaries and with components of the exterior multilayer film listed first)
oriented polyester/tie material/foil/tie material/oriented polyester/tie material/sealant material
biaxially-oriented polyester or biaxially-oriented polypropylene or biaxially-oriented polyamide/tie material/ethylene vinyl alcohol copolymer/tie material/high density polyethylene or low density polyethylene
oriented polyester/foil or metalized film/tie material/polyethylene
oriented polyester/foil or metalized film/tie material/polypropylene/polyethylene/polyethylene
oriented polyester/tie material/polyethylene
oriented polyester/tie material/polypropylene/polyethylene/polyethylene
biaxially-oriented polyester or biaxially-oriented polypropylene or biaxially-oriented polyamide/foil or metalized film/tie material/polyethylene
biaxially-oriented polyester or biaxially-oriented polypropylene or biaxially-oriented polyamide/tie material/polyethylene
polyethylene/polyethylene/tie material/ethylene vinyl alcohol copolymer/tie material/polyethylene/polyethylene/tie material/sealant material
polyethylene or polypropylene/tie material/polyamide/ethylene vinyl alcohol copolymer/polyamide/tie material/polyethylene or polypropylene/tie material/sealant material
polyester/foil or metalized film/tie material/polypropylene/polyethylene For any structure of multilayer film 10 (i.e., not limited to the example structures described above), exterior layer 60 may be printed (e.g., with indicia, ink, etc.) on exterior layer inner surface 62 and/or exterior layer outer surface 64. In instances of printing on exterior layer outer surface 64, the indicia, ink, etc., may be coated with a lacquer, primer or other material to protect the indicia, ink, etc.

Additionally, for any structure of multilayer film 10 (again, not limited to the example structures described above), any aperture or apertures formed in interior layer 66 do not adversely affect barrier properties of multilayer film 10. For example, any aperture or apertures in interior layer 66 terminate at interior layer inner surface 68, do not continue into exterior layer 60 and/or do not extend beyond exterior layer inner surface 62.

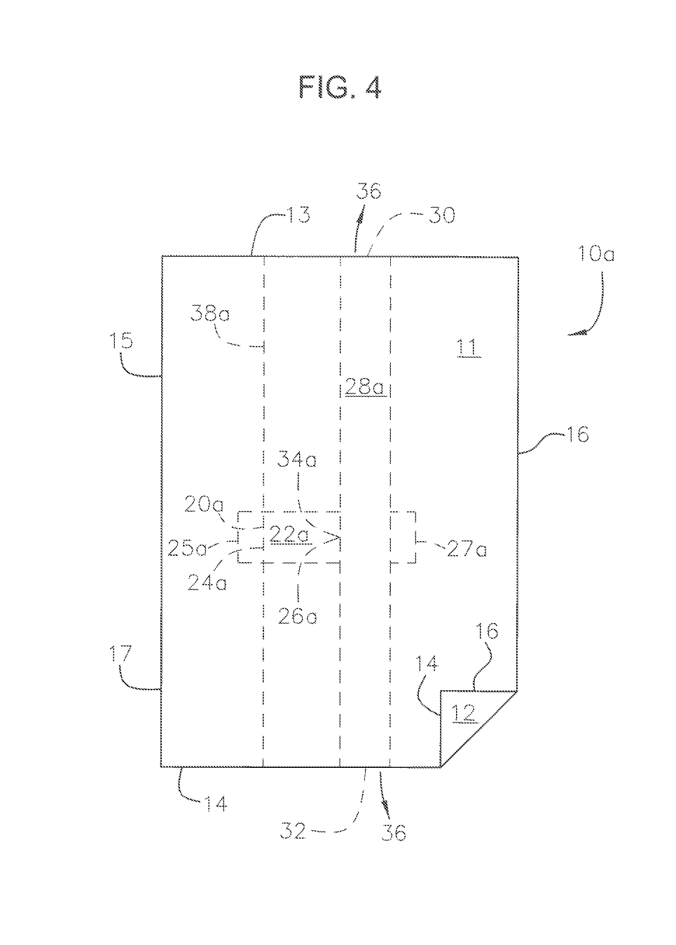

Referring again to the drawings, FIG. 4 is a plan view of a second embodiment of a multilayer film according to the present application. Multilayer film 10a is similar to multilayer film 10. However, for multilayer film 10a, first aperture 20a is a section of score line 38a. Score line 38a extends laterally from first edge 13 to opposing second edge 14 of multilayer film 10a and traverses first channel 22a. As with first aperture 20 described above, score line 38a has a depth extending from an interior layer outer surface to an interior layer inner surface of multilayer film 10a.

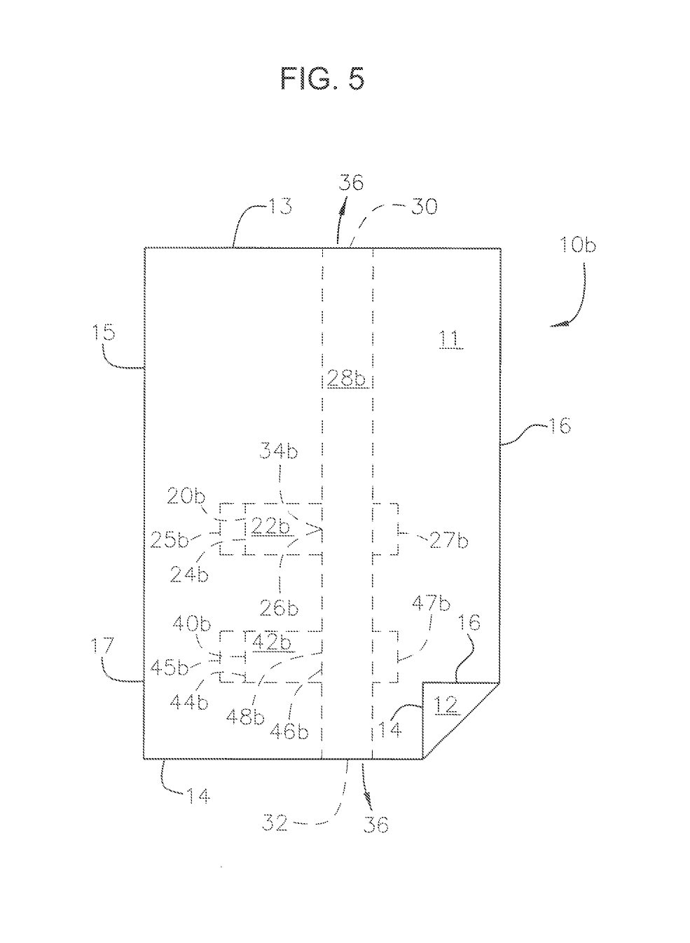

FIG. 5 is a plan view of a third embodiment of a multilayer film according to the present application. Multilayer film 10b is similar to multilayer film 10. However, multilayer film 10b includes second channel 42b formed by a non-bonded portion between an exterior layer and an interior layer of multilayer film 10b. Second aperture 40b is formed in an interior layer of multilayer film 10b and has a depth extending from an interior layer outer surface to an interior layer inner surface. Second aperture 40b is located such that it is in fluid communication with second channel first area 44b. For example, second aperture 40b may be located at or near second channel first end 45b, as depicted in FIG. 5; however, provided there is fluid communication with second channel first area 44b, second aperture 40b is not limited to this location. At second channel second area 46b, second channel 42b intersects with passage 28b at second channel-passage intersection point 48b. Second channel second area 46b may be located at or near second channel second end 47b or may be located at a location separate from second channel second end 47b, as depicted in FIG. 5. No matter its position relative to second channel second end 47b, second channel second area 46b is located at or near second channel-passage intersection point 48b such that second channel second area 46b is in fluid communication with passage 28b. As in FIG. 1 above, the intersection of second channel second area 46b with passage 28b is depicted as occurring at an approximately 90-degree angle. However, as above, such intersection may occur at any angle, provided such angle is greater than 0 degrees and less than 180 degrees. In the embodiment of FIG. 5, first aperture 20b, second aperture 40b, first channel 22b, second channel 42b and passage 28b form the valve allowing for fluid communication from an interior layer outer surface to an external atmosphere.

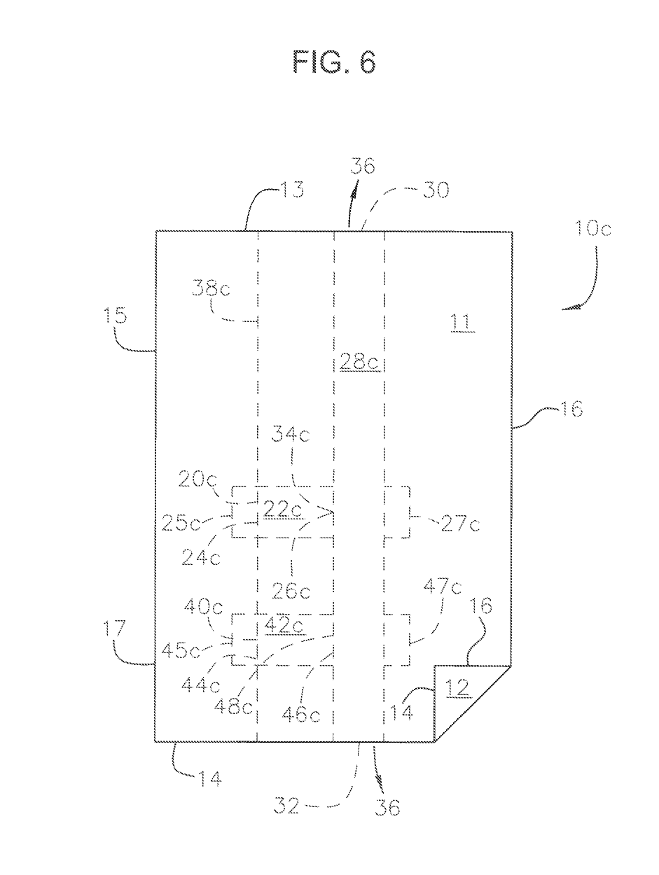

FIG. 6 is a plan view of a fourth embodiment of a multilayer film according to the present application. Multilayer film 10c is similar to multilayer film 10b. However, for multilayer film 10c, first aperture 20c and second aperture 40c is each a section of score line 38c. Score line 38c extends laterally from first edge 13 to opposing second edge 14 of multilayer film 10c and traverses first channel 22c and second channel 42c. Score line 38c has a depth extending from an interior layer outer surface to an interior layer inner surface of multilayer film 10c.

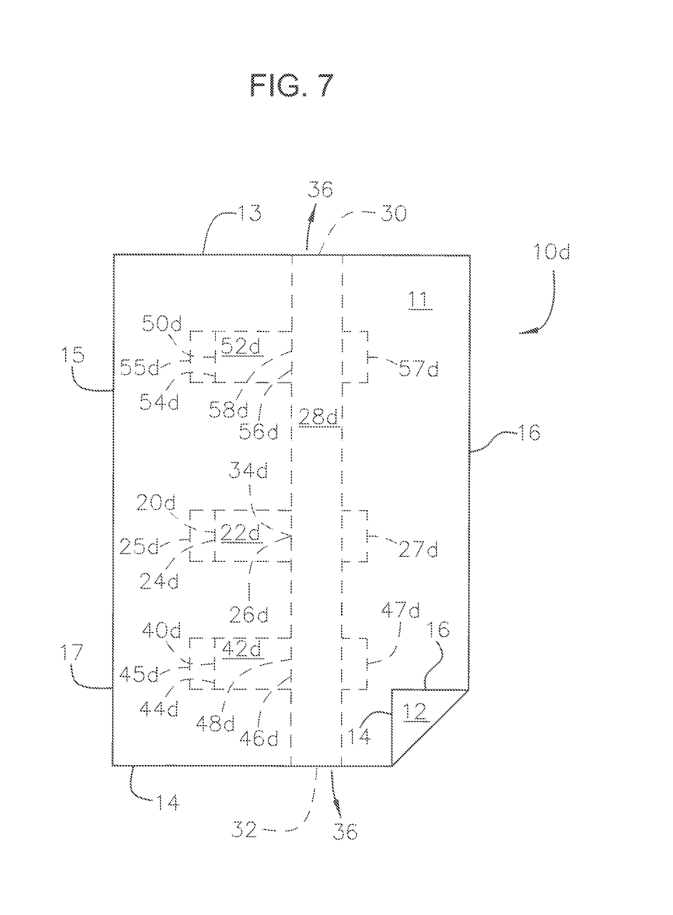

FIG. 7 is a plan view of a fifth embodiment of a multilayer film according to the present application. Multilayer film 10d is similar to multilayer film 10b. However, multilayer film 10d includes third channel 52d formed by a non-bonded portion between an exterior layer and an interior layer of multilayer film 10d. Third aperture 50d is formed in an interior layer of multilayer film 10d and has a depth extending from an interior layer outer surface to an interior layer inner surface. Third aperture 50d is located such that it is in fluid communication with third channel first area 54d. For example, third aperture 50d may be located at or near third channel first end 55d, as depicted in FIG. 7; however, provided there is fluid communication with third channel first area 54d, third aperture 50d is not limited to this location. At third channel second area 56d, third channel 52d intersects with passage 28d at third channel-passage intersection point 58d. Third channel second area 56d may be located at or near third channel second end 57d or may be located at a location separate from third channel second end 57d, as depicted in FIG. 7. No matter its position relative to third channel second end 57d, third channel second area 56d is located at or near third channel-passage intersection point 58d such that third channel second area 56d is in fluid communication with passage 28d. As in FIG. 1 and FIG. 5 above, the intersection of third channel second area 56d with passage 28d is depicted as occurring at an approximately 90-degree angle. However, as above, such intersection may occur at any angle, provided such angle is greater than 0 degrees and less than 180 degrees. In the embodiment of FIG. 7, first aperture 20d, second aperture 40d, third aperture 50d, first channel 22b, second channel 42b, third channel 52b and passage 28b form the valve allowing for fluid communication from an interior layer outer surface to an external atmosphere.

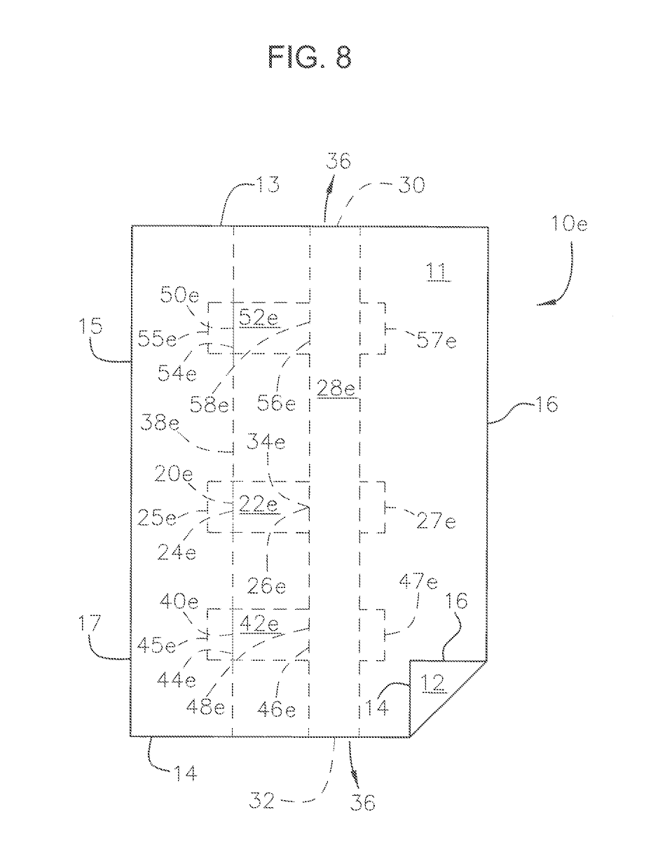

FIG. 8 is a plan view of a sixth embodiment of a multilayer film according to the present application. Multilayer film 10e is similar to multilayer film 10d. However, for multilayer film 10e, first aperture 20e, second aperture 40e and third aperture 50e is each a section of score line 38e. Score line 38e extends laterally from first edge 13 to opposing second edge 14 of multilayer film 10e and traverses first channel 22e, second channel 42e and third channel 52e. Score line 36e has a depth extending from an interior layer outer surface to an interior layer inner surface of multilayer film 10e.

In the figures and the above description, the multilayer film of the present application is shown and described as including up to three channels and as including one passage. However, the multilayer film may comprise any number of channels (and corresponding apertures) and any number of passages. The number of channel(s) and passage(s) is limited only by the dimensions of the multilayer film and the dimensions of the channel(s) and the passage(s). The channel(s) may be of any length, as measured from channel first end to channel second end or as measured from channel first are to channel second area, and the passage(s) may be of any length, as measured from passage first end to passage second end (e.g., from the first edge of the multilayer film to the opposing second edge of the multilayer film). As a non-limiting example, the channel(s) may have a length of from about 0.5 centimeters to about 10 centimeters, as measured from channel first end to channel second end or as measured from channel first area to channel second area. The channel(s) and the passage(s) may be of any width, and the width may vary from one area to another. As a non-limiting example, a channel may have the same width at the channel first area and the channel second area, as depicted in the figures. As an alternative non-limiting example, the channel first area may have a wider width (e.g., to allow for wider gas escape) than the channel second area. If multiple channels are present, a first channel may have a different length and/or width from a second channel; a second channel may have a different length and/or width from a third channel; a third channel may have a different length and/or width from a fourth channel; and so on. Similarly, if multiple passages are present, a first passage may have a different width from a second passage; however, each passage will have the same length (i.e., extending laterally from the first edge of the multilayer film to the opposing second edge of the multilayer film).

Additionally, in the figures, the channels and the passage are shown as straight. However, the channel(s) and/or the passage(s) may bend or otherwise be non-linear (e.g., wavy, zigzag, etc.). Furthermore, the channel(s) and/or the passage(s) may be placed in the transverse direction, the machine direction and/or neither (e.g., diagonal across both directions). Provided the multilayer film comprises a valve (with at least one aperture, at least one channel and at least one passage) allowing for fluid communication from an interior layer outer surface to an external atmosphere and provided each intersection of a channel and a passage occurs at an angle greater than 0 degrees and less than 180 degrees, the placement and location of the channels ) and the passage(s) are limited only by the dimensions and end-use of the film. As a non-limiting example, a person of ordinary skill in the art may determine the dimensions of the channel(s) and the passage(s) based, in part, on the product to be packaged, the gas volume generated by the product and the corresponding gas volume to be discharged to the external atmosphere. As a further non-limiting example (and as further described below), if the film is to be used as a package, the location of each channel and passage is such that each channel (e.g., first channel 22, first channel 22 and second channel 42, or first channel 22, second channel 42 and third channel 52) and each passage (e.g, passage 28) is registered, i.e., placed on the film so that it will be in the body of the package, not solely in a seal or seals of the package.

Also, depending on the end-use of the film, silicone, mesh and/or other material may be placed in the channel(s) and/or the passage(s) to improve valve operation.

The multilayer films described above may be made by a variety of methods. One non-limiting example of a method of making the multilayer film is as follows. A first layer comprising thermoplastic polymer materials is provided as the exterior layer, and a second layer comprising thermoplastic polymer materials is provided as the interior layer to be adjacent to the exterior layer. As described above, the first layer and the second layer may each be a monolayer film or a multilayer film and may each be a cast film, a blown film, an extrusion-coated film, a laminated film or any other film known to a person of ordinary skill in the art. The bonded and non-bonded portions are then provided between the interior layer and the exterior layer. Such portions may be provided by the use of pattern-applied adhesive or by any other method known to a person of ordinary skill in the art. The provision of the non-bonded portion also forms the channels) (e.g., first channel 22, first channel 22 and second channel 42, or first channel 22, second channel 42 and third channel 52) and the passage(s) (e.g., passage 26).

Next, the aperture(s) (e.g., first aperture 20, first aperture 20 and second aperture 40, or first aperture 20, second aperture 40 and third aperture 50) are provided in the interior layer. As described above, mechanical means, optical ablation (e.g., laser) or other methods known to a person of ordinary skill in the art may be used to form a hole, vent, score, slit, slot, perforation, puncture, orifice, opening, inlet or otherwise in the interior layer. For example, the aperture or apertures may be made by scoring the interior layer with a score-line extending laterally from a first edge of the multilayer film to an opposing second edge. The score-line has a depth extending from an outer surface of the interior layer to an inner surface of the interior layer. A first aperture, first and second apertures, first, second and third apertures, first, second, third and fourth apertures, etc. may each be a section of the score-line. As noted above, any aperture is made so as to not adversely affect any barrier properties of the multilayer film. For example, any aperture or apertures in the interior layer terminate at the inner surface of the interior layer, do not continue into the exterior layer and/or do not extend beyond the inner surface of the exterior layer.

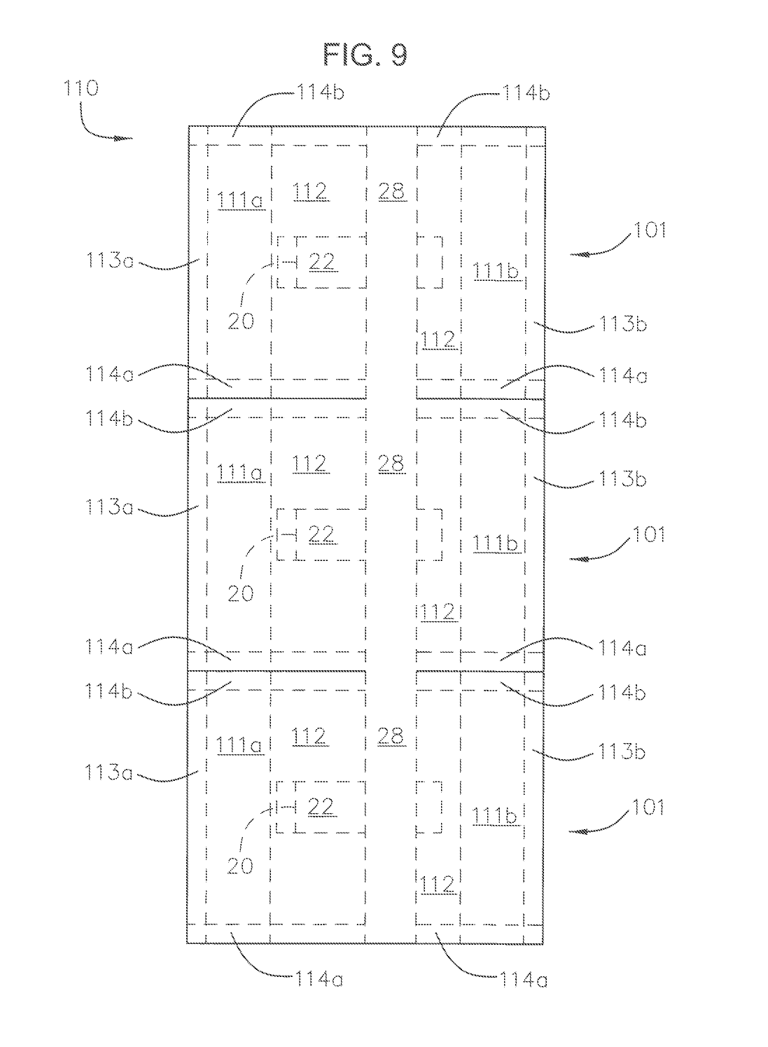

In general, multilayer films for packaging may be produced using a web with repeating patterns or units that then form individual packaging units. Referring again to the drawings, FIG. 9 is a plan view of web 110 comprising multilayer film 10 of FIG. 1 with repeating unit 101 shown in triplicate. Repeating unit 101 may be made in the machine direction of web 110 or in the transverse direction of web 110. Multilayer film 10 of FIG. 1 is used as a non-limiting example; other embodiments of the multilayer film, including but not limited to those described in the present application such as multilayer film 10a of FIG. 4, multilayer film 10b of FIG. 5, multilayer film 10c of FIG. 6, multilayer film 10d of FIG. 7 and multilayer film 10e of FIG. 8, may be used to form a web.

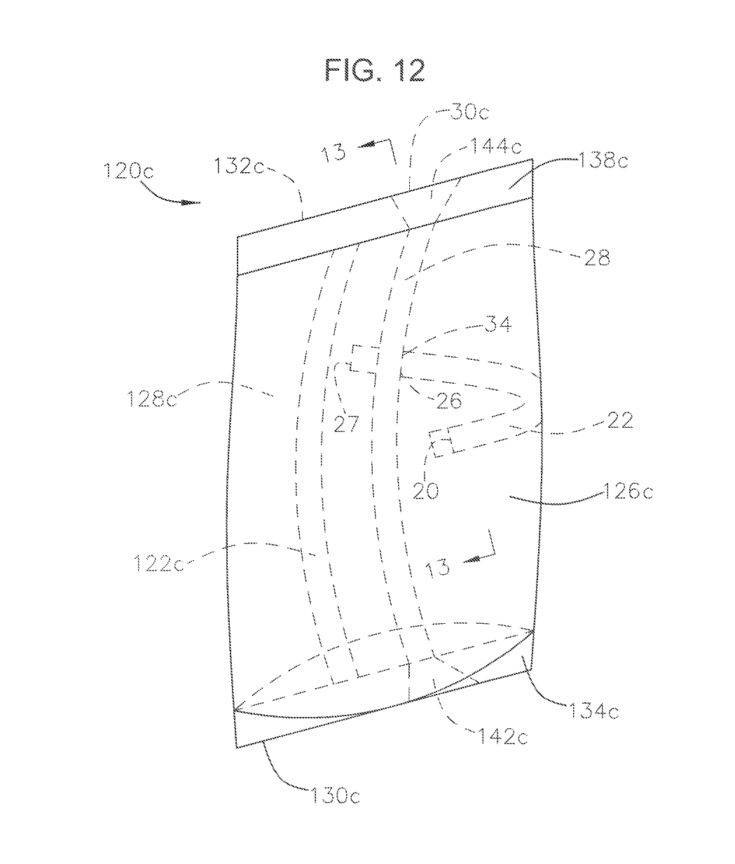

As depicted in FIG. 9, each repeating unit 101 (as exemplified by but not limited to multilayer film 10 of FIG. 1), comprises first aperture 20, first channel 22 and passage 28. Additionally, each repeating unit 101 comprises first area first section 111a, first area second section 11b and second area 112. In forming an individual packaging unit, such as package 120c depicted in FIG. 12, first area first section 111a and first area second section 11b form second wall of 128c of package 120c and second area 112 forms first wall of 126c of package 120c when longitudinal strip first segment 113a and longitudinal strip second segment 113b are sealed to produce first seal 122c. Additionally, in forming package 20c, first transversal strip 114a forms second seal 134c and second transversal strip 114b forms third seal 138c.

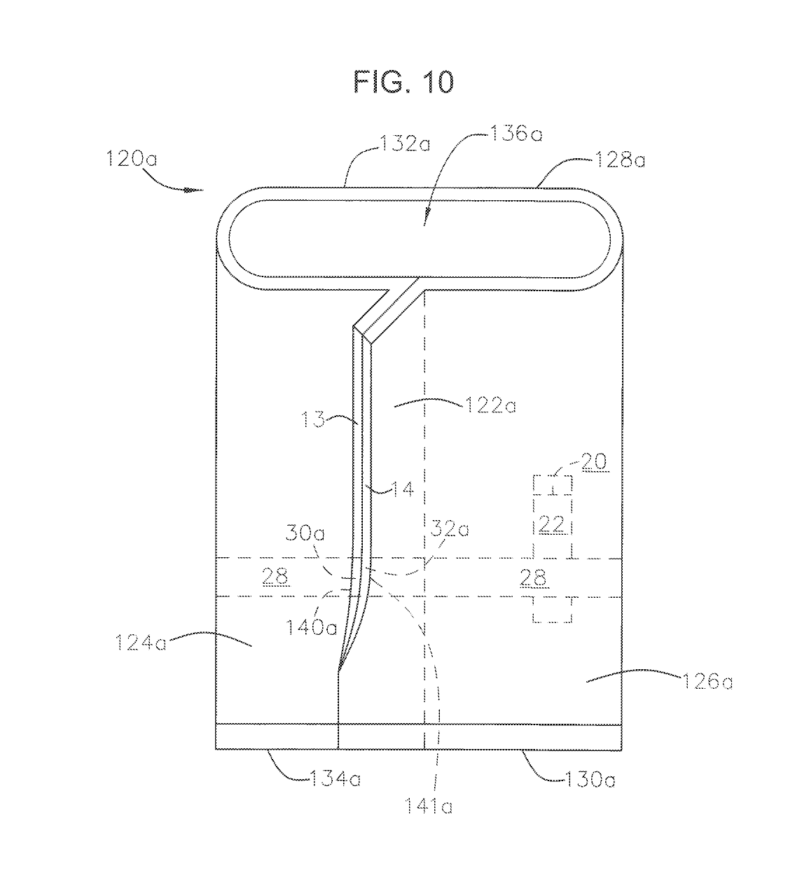

FIG. 10 is a perspective view of a first embodiment of a package comprising the multilayer film of FIG. 1. Multilayer film 10 of FIG. 1 is used as a non-limiting example; other embodiments of the multilayer film, including but not limited to those described in the present application such as multilayer film 10a of FIG. 4, multilayer film 10b of FIG. 5, multilayer film 10c of FIG. 6, multilayer film 10d of FIG. 7 ad multilayer film 10e of FIG. 8, may be used to form packages. Package 120a of FIG. 10 is formed by joining first edge 13 and opposing second edge 14 of multilayer film 10 and sealing to produce first seal 122a, depicted in FIG. 10 as a fin-type seal. The joining of first edge 13 to opposing second edge 14 for first seal 122a also forms tube member 124a. Tube member 124a has first wall 126a, second wall 128a, first end 130a and second end 132a. Second seal 134a is provided through first wall 126a and second wall 128a and extends laterally across the width of both first wall 126a and second wall 128a at a position proximate first end 130a, thereby forming a package with a closed end and product receiving chamber 136a. Product receiving chamber 136a is defined by first wall 126a, second wall 28a, second seal 34a and second end 32a. To finish package 20a, a product (not depicted in FIG. 10) is placed in product receiving chamber 136a. A third seal (not depicted in FIG. 10) is provided through first wall 126a and second wall 128a and extends laterally across the width of both first wall 126a and second wall 128a at a position proximate second end 132a. Package 120a further includes a first outlet having first outlet first area 140a and first outlet second area 141a in first seal 122a. In the embodiment of FIG. 10, the first outlet (including first outlet first area 140a and first outlet second area 141a), first aperture 20, first channel 22 and passage 28 form the valve allowing for fluid communication from an interior layer outer surface to an external atmosphere. First outlet first area 140a is in fluid communication with passage first end 30a, and first outlet second area 141a is in fluid communication with passage second end 32a. Passage first end 30a and passage second end 32a is each in fluid communication with an external atmosphere. This construction assures that the gas-discharge valve will continue to operate even if non-conformities occur during film production and/or package formation. For example, if such non-conformities cause first outlet first area 140a to be sealed at passage first end 30a, first outlet second area 41a maintains the valve's fluid communication with an external atmosphere through passage second end 32a.

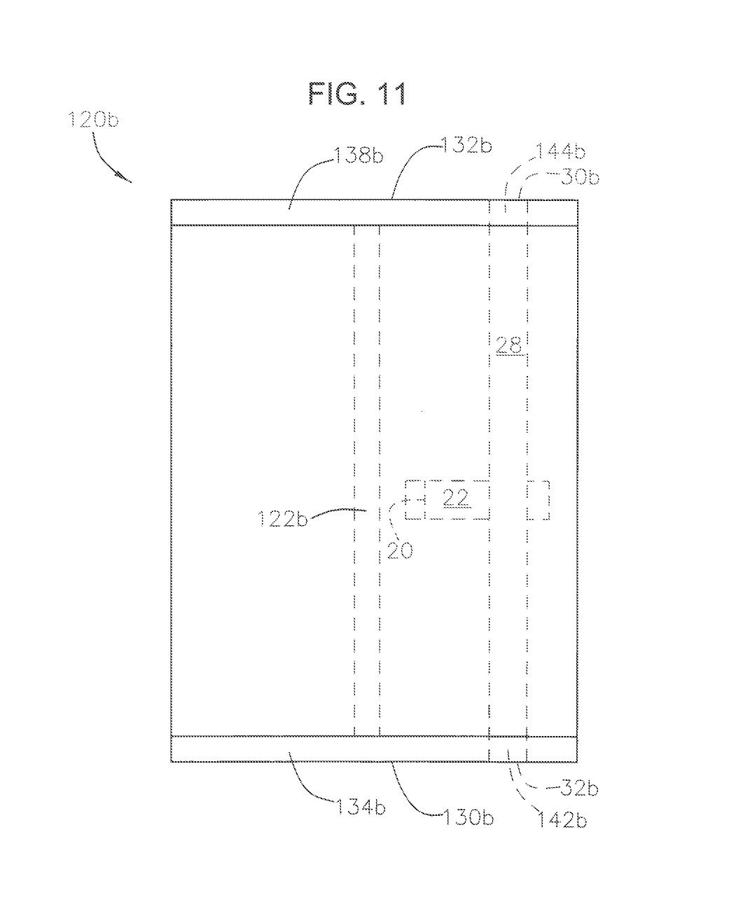

FIG. 11 is a plan view of a second embodiment of a package comprising the multilayer film of FIG. 1. Again, as above, multilayer film 10 of FIG. 1 is used as a non-limiting example; other embodiments of the multilayer film, including but not limited to those described in the present application such as multilayer film 10a of FIG. 4, multilayer film 10b of FIG. 5, multilayer film 10c of FIG. 6, multilayer film 10d of FIG. 7 and multilayer film 10e of FIG. 8, may be used to form packages. Package 120b of FIG. 11 depicts a finished package. First seal 122b is formed by joining a first side and an opposing second side (not specifically depicted in FIG. 1 but exemplified by first side 15 and opposing second side 16 in FIG. 1) of multilayer film 10 and sealing to produce first seal 122b, depicted in FIG. 11 as a backseam fin-type seal, lap-type seal or other seal configuration. Second seal 134b is provided through a first wall and a second wall (not specifically depicted in FIG. 11) and extends laterally across the width of both the first wall and the second wall at a position proximate first end 130b. Third seal 138b is provided through the first wall and the second wall and extends laterally across the width of both the first wall and the second wall at a position proximate second end 132b. Package 120b further includes second outlet 142b in second seal 34b and third outlet 144b in third seal 138b. In the embodiment of FIG. 11, second outlet 142b, third outlet 144b, first aperture 20, first channel 22 and passage 28 form the valve allowing for fluid communication from an interior layer outer surface to an external atmosphere. Second outlet 142b is in fluid communication with passage second end 32b, and third outlet 144b is in fluid communication with passage first end 30b. Passage first end 30b and passage second end 32b are in fluid communication with an external atmosphere. This construction assures that the gas-discharge valve will continue to operate even if non-conformities occur during film production and/or package formation. For example, if such non-conformities cause second outlet 142b to be sealed at passage second end 32b, third outlet 144b maintains the valve's fluid communication with an external atmosphere through passage first end 30b.

FIG. 12 is a perspective view of a third embodiment of a package comprising the multilayer film of FIG. 1. Again, as above, multilayer film 10 of FIG. 1 is used as a non-limiting example; other embodiments of the multilayer film, including but not limited to those described in the present application such as multilayer film 10a of FIG. 4, multilayer film 10b of FIG. 5, multilayer film 10c of FIG. 6, multilayer film 10d of FIG. 7 and multilayer film 10e of FIG. 8, may be used to form packages. Package 120c of FIG. 12 depicts a finished package. First seal 122c is formed by joining a first side and an opposing second side (not specifically depicted in FIG. 12 but exemplified by first side 15 and opposing second side 16 in FIG. 1) of multilayer film 10 and sealing to produce first seal 122c, depicted in FIG. 2 as a backseam fin-type seal, lap-type seal or other seal configuration. Second seal 134c is provided through first wall 126c and second wall 128c and extends laterally across the width of both first wall 26c and second wall 128c at a position proximate first end 130c. Third seal 138c is provided through first wall 126c and second wall 126c and extends laterally across the width of both first wall 126c and second wall 128c at a position proximate second end 132c. Package 120c further includes second outlet 142c in second seal 134c and third outlet 144c in third seal 138c (at passage first end 30c). In the embodiment of FIG. 12, second outlet 142c, third outlet 144c, first aperture 20, first channel 22 and passage 28 form the valve allowing for fluid communication from an interior layer outer surface to an external atmosphere.

For package 120c, first channel 22 extends laterally from first wall 126c to second wall 128c of package 120c. In other words, first channel 22 wraps around from one side of package 120c to the other. In this embodiment, first aperture 20 is in first wall 126c of package 120c. Passage 28, first channel second area 26, first channel second end 27 and first channel-passage intersection point 34 is each in second wall 128c of package 120c.

As mentioned above, other embodiments of the multilayer film may be used to form packages. For example, if multilayer film 10b of FIG. 5 is used to form a package, first channel 22b and second channel 42b could each extend laterally from a first wall to a second wall, each wrapping around from one side of the package to the other. In this embodiment, first aperture 20b and second aperture 40b would each be in a first wall of the package; and passage 28b, first channel second area 26b, second channel second area 46b, first channel second end 27b, second channel second end 47b, first channel-passage intersection point 34b and second channel-passage intersection point 48b would each be in a second wall of the package. As a further non-limiting example, if multilayer film 10d of FIG. 7 is used to form a package, first channel 22d, second channel 42d and third channel 52d could each extend laterally from a first wall to a second wall, each wrapping around from one side of the package to the other. In this embodiment, first aperture 20d, second aperture 40d and third aperture 50d would each be in a first wall of the package; and passage 28d, first channel second area 26d, second channel second area 46d, third channel second area 56d, first channel second end 27d, second channel second end 47d, third channel second end 57d, first channel-passage intersection point 34d, second channel-passage intersection point 48d and third channel-passage intersection point 58d would each be in a second wall of the package.

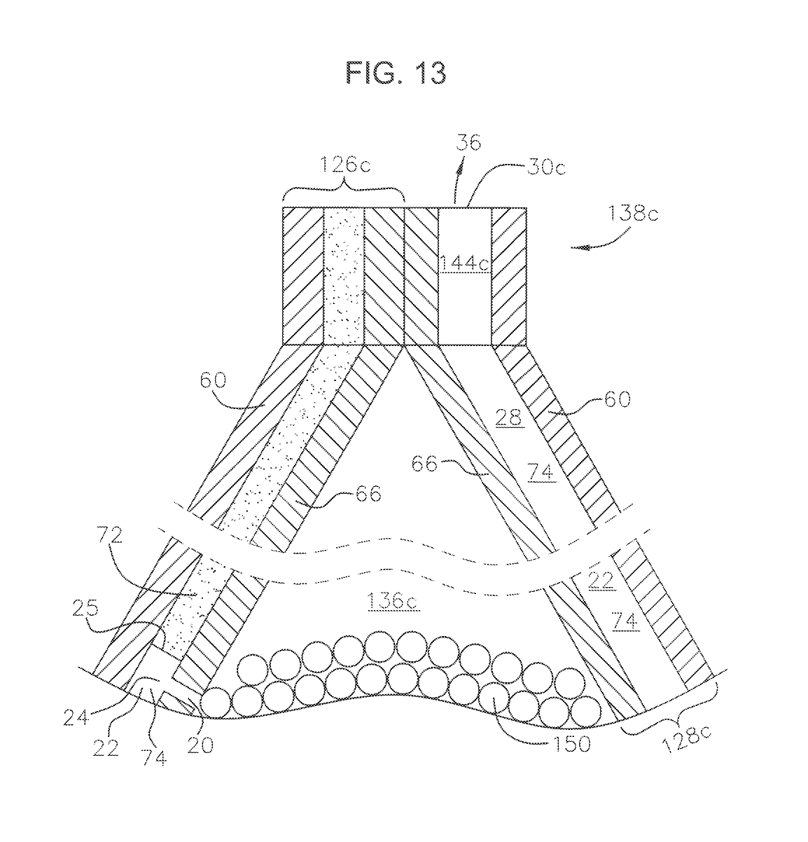

FIG. 13 is a cross-sectional view of the package of FIG. 12, taken along the lines 13-13 of FIG. 12. In FIG. 13, product 150 is placed in product receiving chamber 136c. As a non-limiting example, product 150 may be coffee beans or coffee powder. As described above, due in part to the packaging procedure, the film used to form the package and/or the particular characteristics of coffee, gases are known to form in a sealed coffee package. As depicted in FIG. 3, first aperture 20 is present in interior layer 66 of first wall 126c. In the embodiment depicted in FIG. 13, first aperture 20 serves as the valve inlet and is in fluid communication with first channel first area 24, with first channel 22 having first channel first end 25. The pressure in product receiving chamber 136 of package 120c is higher than the pressure in external atmosphere 36. Therefore, gases flow from product receiving chamber 136c into first channel 22 through aperture 20. Bonded portion 72 between interior layer 66 and exterior layer 60 and non-bonded portion 74 between interior layer 66 and exterior layer 60 assist the flow of gases into first channel 22.

As depicted in FIG. 12, first channel 22 (formed, in part, by non-bonded portion 74 between interior layer 66 and exterior layer 60) extends laterally from first wall 126c to second wall 128c, wrapping around from one side of package 120c to the other. As depicted in FIG. 12 (and occurring in the cut-away of FIG. 13), first channel second area 26 intersects passage 28 at an angle greater than 0 degrees and less than 180 degrees at first channel-passage intersection point 34 in second wall 128c. First channel second area 26 is in fluid communication with passage 28 and gases from product receiving chamber 136c continue to flow through package 120c and multilayer film 10.

In the embodiment shown in FIG. 3, gases continue to flow through passage 28 (formed, in part, by non-bonded portion 74 between interior layer 66 and interior layer 60) to external atmosphere 36. In the embodiment depicted in FIG. 12 and FIG. 13, third outlet 144c is present in third seal 138c and is in fluid communication with passage first end 30c. Passage 28 is in fluid communication with external atmosphere 36 through passage first end 30c; and, in the embodiment depicted in FIG. 13, passage first end 30c serves as the valve outlet.

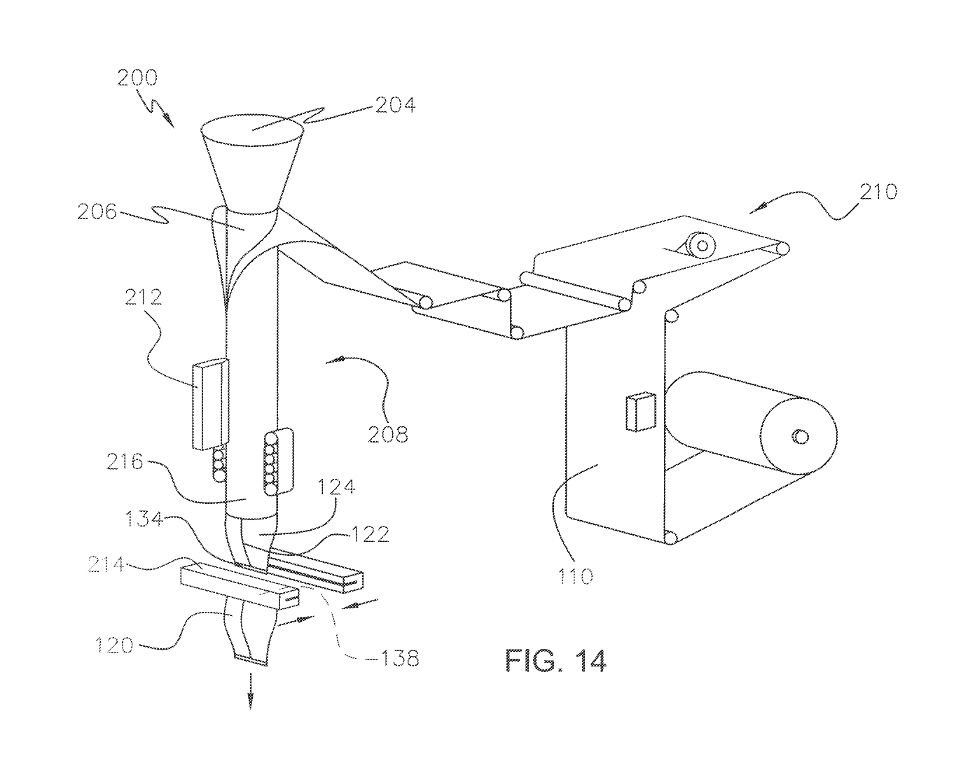

The packages described above may be formed by a variety of methods. One non-limiting example of a method of forming a package is depicted in FIG. 14. FIG. 14 is a perspective view of a method of manufacturing packages according to the present application. An exemplary belt-driven VFFS (vertical form-fill-seal) machine 200 generally comprises funnel 204 coupled to first end 206 of elongated tubular portion 208. Web assembly 210 carries to and moves web 110 of a multilayer film around and longitudinally along elongated tubular portion 208. The web may be pre-printed via indicia, ink, etc, with text, graphics or otherwise. First sealing assembly 212 is used to form first seal 122 of package 120. Such sealing may be ultrasonic sealing, heat sealing, pressure sealing or any other sealing method known to a person of ordinary skill in the art. Also, such seals may be straight (as depicted) or may be non-linear in the form of a wavy line, zigzag shape or other shape as desired. Furthermore, the width of the seal may be varied to be thicker or thinner as desired. As described above, first seal 122 of package 120 connects a first side of the multilayer film to an opposing second side of the multilayer film (or a first edge of the multilayer film to an opposing second edge of the multilayer film) and forms tube member 124 having a first wall, a second wall, a first end and a second end.

Second sealing assembly 214 is then used to form second seal 134. (The arrows adjacent second sealing assembly 214 in FIG. 14 depict a direction of movement of second sealing assembly 214.) Second sealing assembly 2 4 may be the same or different configuration and/or sealing as first sealing assembly 212. As described above, second seal 134 is provided through the first wall of tube member 24 and the second wall of tube member 124 and extends laterally across the width of both the first wall and the second wall at a position proximate the first end of tube member 124. Second 134 seal assists in forming a product receiving chamber. The product receiving chamber is defined by the first wall of tube member 124, the second wall of tube member 124, second seal 134 and the second end of tube member 124.

Following the formation of second seal 134, an amount of product is introduced into funnel 204 such that product is provided in the product receiving chamber. The filled, semi-sealed, in-process package 120 is then moved off of second end 216 of elongated tubular portion 208, such that it is supported only by web 110. (The arrow adjacent package 120 in FIG. 14 depicts a direction of movement of package 120.) Second sealing assembly 214 then simultaneously forms third seal 138 (hidden by second sealing assembly 214 in FIG. 14) for package 120 while also forming second seal 134 of a yet-to-be-filled package 120 being formed on elongated tubular portion 208. Similar to second seal 134, third seal 138 is provided through the first wall of tube member 124 and the second wall of tube member 124 and extends laterally across the width of both the first wall and the second wall at a position proximate the second end of tube member 124.

A first area of a first outlet and a second area of a first outlet may each be formed in first seal 122 or a second outlet may be formed in second seal 134 and a third outlet may be formed in third seal 38. As described above, such outlets are intended to be in fluid communication with ends of the passage. As such, such outlets may be gaps, interruptions or other non-sealed areas of first seal 122, second seal 134 and/or third seal 138. Such gaps or other non-sealed areas may be formed by the use of a skip in the seal bar(s) in first sealing assembly 212 and/or second sealing assembly 214. Such gaps or other non-sealed areas may also be formed based on material selection (i.e, the materials forming the outer surfaces of the exterior layer and/or interior layer of the multilayer film) or by any other method known to a person of ordinary skill in the art.

In forming package 120, VFFS machine 200 is adjusted with undue experimentation by a person of ordinary skill in the art such that none of first seal 122, second seal 134 or third seal 138 fully contains any channel(s) or passage(s) in final package 120; however, as described above, first seal 122, second seal 134 or third seal 138 may intersect channel(s) and/or passage(s). In other words, each channel and/or passage is registered, i.e., located in the body of package 120 and not solely in first seal 122, second seal 134 or third seal 138.

The above description, examples and embodiments disclosed are illustrative only and should not be interpreted as limiting. The present invention includes the description, examples and embodiments disclosed; but it is not limited to such description, examples or embodiments. Modifications and other embodiments will be apparent to those skilled in the art, and all such modifications and other embodiments are intended and deemed to be within the scope of the present invention as defined by the claims.

What is claimed is as follows:

1. A multilayer film corn fling a valve,
wherein the multilayer film comprises
a. a perimeter comprising a first edge and an opposing second edge and a first side and an opposing second side,
b. an exterior layer having an inner surface and an outer surface,
c. an interior layer adjacent to the exterior layer, wherein the interior layer has an inner surface and an outer surface and wherein the interior layer comprises a first aperture having a depth extending from the outer surface of the interior layer to the inner surface of the interior layer,
d. a bonded portion between the interior layer and the exterior layer and
e. a nonbonded portion between the interior layer and the exterior layer, wherein the nonbonded portion comprises a first channel having a first area and a second area and further comprises a passage having a first end and a second end,
wherein the valve comprises the first aperture, the first channel and the passage and is in fluid communication from the outer surface of the interior layer to an atmosphere external to the multilayer film, whereby the first aperture is in fluid communication with the first area of the first channel, whereby the second area of the first channel intersects the passage at an angle greater than 0 degrees and less than 180 degrees and is in fluid communication with the passage and whereby the passage extends laterally from the first edge to the opposing second edge and the first end of the passage and the second end of the passage is each in fluid communication with the atmosphere external to the multilayer film.

2. The film of claim 1 wherein the interior layer comprises a score-line extending laterally from the first edge of the film to the opposing second edge, wherein the score-line has a depth extending from the outer surface of the interior layer to the inner surface of the interior layer and wherein the first aperture is a section of the score-line.

3. The film of claim 1 wherein the interior layer further comprises a second aperture having a depth extending from the outer surface of the interior layer to the inner surface of the interior layer, wherein the non-bonded portion further comprises a second channel having a first area and a second area and wherein the valve further comprises the second aperture and the second channel, whereby the second aperture is in fluid communication with the first area of the second channel and whereby the second area of the second channel is in fluid communication with the passage and intersects the passage at an angle greater than 0 degrees and less than 180 degrees.

4. The film of claim 3 wherein the inferior layer comprises a score-line extending laterally from the first edge of the film to the opposing second edge, wherein the score-line has a depth extending from the outer surface of the interior layer to the inner surface of the interior layer and wherein the first aperture and the second aperture is each a section of the score-line.

5. The film of claim 3 wherein the interior layer further comprises a third aperture having a depth extending from the outer surface of the interior layer to the inner surface of the interior layer, wherein the non-bonded portion further comprises a third channel having a first area and a second area and wherein the valve further comprises the third aperture and the third channel, whereby the third aperture is in fluid communication with the first area of the third channel and whereby the second area of the third channel is in fluid communication with the passage and intersects the passage at an angle greater than 0 degrees and less than 180 degrees.

6. The film of claim 5 wherein the interior layer comprises a score-line extending laterally from the first edge of the multilayer film to the opposing second edge, wherein the score-line has a depth extending from the outer surface of the interior layer to the inner surface of the interior layer and wherein the first aperture, the second aperture and the third aperture is each a section of the score-line.

7. The film of claim 1 wherein the inferior layer comprises a sealant layer.

8. The film of claim 7 wherein the sealant layer comprises polyethylene, polypropylene or blends thereof.

9. The film of claim 1 wherein the interior layer comprises an interior multilayer film.

10. The film of claim 9 wherein the interior multilayer film comprises a first layer comprising polyethylene, a second layer comprising polyethylene and a third layer comprising polypropylene.

11. The film of claim 9 wherein the interior multilayer film comprises a first layer comprising sealant material and a second layer comprising polyester.

12. The film of claim 9 wherein the Interior multilayer film comprises a first layer comprising polyethylene and a second layer comprising polypropylene.

13. The film of claim 1 wherein the exterior layer comprises a barrier layer.

14. The film of claim 13 wherein the barrier layer comprises ethylene vinyl alcohol copolymer, polyvinyl alcohol, polyester, polypropylene, poly-amide, metalized film, metal-oxide coated film, foil, nanocomposite, polyvinylidene chloride, polyglycolic acid, polyacrylonitrile, polyalkylene carbonate, methyl acrylate copolymer, polyethylene or blends thereof.

15. The film of claim 1 wherein the exterior layer comprises an exterior multilayer film.

16. The film of claim 15 wherein the exterior multilayer film comprises a first layer comprising polyester and a second layer comprising foil, metalized film or metal-oxide coated film.

17. The film of claim 15 wherein the exterior multilayer film comprises a first layer comprising polyester, polypropylene or polyamide and a second layer comprising ethylene vinyl alcohol copolymer.

18. The film of claim 15 wherein the exterior multilayer film comprises a first layer comprising polyethylene, a second layer comprising polyethylene, a third layer comprising ethylene vinyl alcohol copolymer, a fourth layer comprising polyethylene and a fifth layer comprising polyethylene.

19. The film of claim 15 wherein the exterior multilayer film comprises a first layer comprising polyethylene or polypropylene, a second layer comprising polyamide, a third layer comprising ethylene vinyl alcohol copolymer, a fourth layer comprising polyamide and a fifth layer comprising polyethylene or polypropylene.

20. The film of claim 1 wherein the exterior layer comprises indicia printed on the inner surface of the exterior layer, on the outer surface of the exterior layer or on both the inner surface and the outer surface of the exterior layer.

21. A web comprising repeating units wherein each repeating units comprises the first aperture, the first channel and the passage of the film of claim 1.

22. A package comprising the film of claim 1 wherein the package further comprises
a. a first seal connecting the first side of the film to the opposing second side of the film or the first edge of the film to the opposing second edge of the film and defining a tube member having a first wall, a second wall, a first end and a second end,
b. a second seal provided though the first wall and the second wall, wherein the second seal extends laterally across the width of both the first wall and the second wall at a position proximate the first end, whereby a product receiving chamber is defined by the first wall, the second wall, the second seal and the second end,
c. a product in the product receiving chamber and
d. a third seal provided through the first wall and the second wall, wherein the third seal extends laterally across the width of both the first wall and the second wall at a position proximate the second end.

23. The package of claim 22 wherein the first seal comprises a first outlet having a first area and a second area and wherein the valve further comprises the first outlet, whereby the first area of the first outlet is in fluid communication with the first end of the passage and the second area of the first outlet is in fluid communication with the second end of the passage.

24. The package of claim 22 wherein the second seal comprises a second outlet, wherein the third seal comprises a third outlet and wherein the valve further comprises the second outlet and the third outlet, whereby the second outlet is in fluid communication with the second end of the passage and the third outlet is in fluid communication with the first end of the passage.

25. The package of claim 22 wherein the first channel extends laterally from the first wall to the second wall

26. The package of claim 22 wherein the non-bonded portion further comprises a second channel.

27. The package of claim 26 wherein the first channel and the second channel each extends laterally from the first wall to the second wall.

28. The package of claim 28 wherein the non-bonded portion further comprises a third channel.

29. The package of claim 28 wherein the first channel, the second channel and the third channel each extends laterally from the first wall to the second wall.

30. A method of making the film of claim 1 wherein the method comprises
a. providing a first layer as the exterior layer;
b. providing a second layer as the interior layer adjacent to the exterior layer;
c. providing the bonded portion between the interior layer and the exterior layer;
d. providing the non-bonded portion between the interior layer and the exterior layer to form the first channel and to further form the passage; and
e. providing the first aperture in the interior layer.

31. The method of claim 30 wherein the step of providing the first aperture comprises scoring the interior layer with a score-line extending laterally from the first edge of the film to the opposing second edge, wherein the score-line has a depth extending from the outer surface of the interior layer to the inner surface of the interior layer and wherein the first aperture is a section of the score-line.

32. The method of claim 30 wherein the method further comprises providing a second aperture in the interior layer, wherein the second aperture has a depth extending from the outer surface of the interior layer to the inner surface of the interior layer, and wherein the step of providing the non-bonded portion further comprises forming a second channel having a first area and a second area.

33. The method of claim 32 wherein the steps of providing the first aperture and providing the second aperture comprise scoring the inferior layer with a score-line extending laterally from the first edge of the film to the opposing second edge, wherein the score-line has a depth extending from the outer surface of the interior layer to the inner surface of the interior layer and wherein the first aperture and the second aperture is each a section of the score-line.

34. The method of claim 32 wherein the method further comprises providing a third aperture in the interior layer, wherein the third aperture has a depth extending from the outer surface of the interior layer to the inner surface of the interior layer, and wherein the step of providing the non-bonded portion further comprises forming a third channel having a first area and a second area.

35. The method of claim 34 wherein the steps of providing the first aperture, providing the second aperture and providing the third aperture comprise scoring the interior layer with a score-line extending laterally from the first edge of the film to the opposing second edge, wherein the score-line has a depth extending from the outer surface of the interior layer to the inner surface of the interior layer and wherein the first aperture, the second aperture and the third aperture is each a section of the score-line.

36. A method of forming a package comprising the film of claim 1 wherein the method comprises
a. providing a web of the film;
b. providing a first seal connecting the first side of the film to the opposing second side of the film or the first edge of the film to the opposing second edge of the film to form a tube member having a first wall, a second wall, a first end and a second end;
c. providing a second seal though the first wall and the second wall, wherein the second seal extends laterally across the width of both the first wall and the second wall at a position proximate the first end;
d. providing a product receiving chamber defined by the first wall, the second wall, the second seal and the second end;
e. providing a product in the product receiving chamber; and
f. providing a third seal through the first wall and the second wall, wherein the third seal extends laterally across the width of both the first wall and the second wall at a position proximate the second end.

37. The method of claim 36 further comprising forming a first area of a first outlet and forming a second area of the first outlet in the first seal.

38. The method of claim 36 further comprising forming a second outlet In the second seal and forming a third outlet In the third seal.

39. The method of claim 38 further comprising registering the first channel.

40. The method of claim 38 wherein the non-bonded portion of the film further comprises a second channel.

41. The method of claim 40 further comprising registering the first channel and registering the second channel.

42. The method of claim 40 wherein the non-bonded portion of the film further comprises a third channel.

43. The method of claim 42 further comprising registering the first channel, registering the second channel and registering the third channel.
